(19) United States
(12) Patent Application Publication
(10) Pub. No.: US 2026/0183982 A1
(43) Pub. Date: Jul. 2, 2026

(54) RECONFIGURABLE AND COLLAPSIBLE MATERIAL SUPPORT DEVICE

(71) Applicant: T&J Flooring, LLC, Marshalltown, IA (US)

(72) Inventor: Timothy Mastin, Marshalltown, IA (US)

(73) Assignee: T&J Flooring, LLC, Marshalltown, IA (US)

(21) Appl. No.: 19/008,370

(22) Filed: Jan. 2, 2025

(51) Int. Cl. B26D 7/01

(52) U.S. Cl. CPC B26D 7/01

(57) ABSTRACT

A modular and collapsible material support device is disclosed, comprising a base with an open center portion and a plurality of slat mounting points. The device includes slats, slat risers, and slat elbows that are removably and reconfigurably connected to the base. The slats are elevated above the base to provide a versatile working surface for supporting materials during various tasks. The base is adaptable for placement on diverse surfaces, including garbage containers, benches, trailers, and flat workspaces, and may feature skid-resistant feet, leveling adjustments, or surface enhancements for durability. The slats are customizable in height, spacing, and orientation, and can include surface textures to enhance grip or enable smooth material movement. Threaded, slip-fit, or compression-fit connections allow for easy assembly and disassembly. The device can be reconfigured for different applications and collapsed for convenient storage and transport, making it ideal for versatile material support needs.

### FIELD OF THE INVENTION

The present invention relates to material support systems for cutting operations. Specifically, but not exclusively, the invention pertains to a reconfigurable and collapsible material support device.

### BACKGROUND

Material cutting supports, such as sawhorses and cutting jigs, are commonly used in various industries and home applications. While some supports are collapsible or reconfigurable, they often lack the versatility needed for diverse cutting operations or the ability to adapt to different surfaces. Existing devices may also fail to prevent damage to the surfaces upon which they rest. Therefore, a need exists for a material cutting device that combines modularity, ease of reconfiguration, and compatibility with a variety of surfaces. Such a device should allow users to position, elevate, and customize slats to accommodate materials of different shapes and sizes, while also preventing damage to the supporting surface and being collapsible for easy storage and transport.

### SUMMARY

Therefore, it is a primary object, feature, or advantage of the present invention to improve over the state of the art.

It is an object of the present invention to provide a material cutting device with a base having a plurality of slat mounting points to allow for flexible and reconfigurable positioning of slats.

It is a further object of the present invention to provide a material cutting device with slats that can be elevated above the base to provide a working surface and prevent tools or blades from damaging the base or underlying surfaces.

It is still further an object of the present invention to provide a material cutting device that includes slat risers and elbows to enable customizable adjustment of slat height, spacing, and orientation.

It is another object of the present invention to provide a material cutting device with slats that may be configured as single-piece, multi-piece, or modular assemblies to accommodate materials of varying shapes, sizes, and cutting requirements.

It is yet another object of the present invention to provide a material cutting device where slats can have surface enhancements, such as gripping or grip-free surfaces, to optimize material handling during use.

It is still another object of the present invention to provide a material cutting device that can be placed securely on a variety of surfaces, including garbage containers, benches, trailers, and flat workspaces, enabling debris collection or stability during use.

It is a further object of the present invention to provide a material cutting device with a base that includes skid-resistant feet, anti-skid enhancements, or adjustable leveling feet for stability on uneven or smooth surfaces.

It is another object of the present invention to provide a material cutting device with a base that can include surface enhancements to protect against damage caused by tools, debris, or repeated cutting operations.

It is still further an object of the present invention to provide a material cutting device with slats that can be round, non-round, or have flat surfaces to increase or decrease working surface contact depending on material needs.

It is yet another object of the present invention to provide a modular and collapsible material cutting device that can be easily disassembled for storage and transport while maintaining durability and ease of use.

It is still another object of the present invention to provide a material cutting device that accommodates threaded, slip-fit, compression-fit, or similar connections between slats, risers, elbows, and mounting points, enabling secure and versatile assembly.

It is yet further an object of the present invention to provide a material cutting device with a base that can be circular, square, rectangular, or other shapes to ensure compatibility with various containers or workspaces.

In at least one aspect, the material cutting device comprises a base with an open center portion, a plurality of slat mounting points, and at least one slat removably connected to the slat mounting points. The slat is supported at a distance above the base, and the base is configured to rest on various surfaces.

In another aspect, the system for supporting materials for cutting includes a planar base with an open center portion and a plurality of slat mounting points. At least one slat is removably connected to the mounting points, and the system is reconfigurable to adjust the placement, orientation, and spacing of the slat to support materials of varying sizes and shapes.

In still another aspect, the method for assembling a material cutting device involves providing a base with slat mounting points, positioning at least one slat into selected ones of the mounting points, and adjusting the configuration of the slat to accommodate materials for cutting.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

### BRIEF DESCRIPTION OF THE DRAWINGS

Illustrated embodiments of the disclosure are described in detail below with reference to the attached drawing figures, which are incorporated by reference herein.

FIG. 1 is a perspective view of a material cutting device positioned atop a garbage container.

FIG. 2 is a perspective view of the material cutting device positioned on a flat surface.

FIG. 3 is a top view of the base showing a configuration of the slats.

FIG. 4 is a side view of the material cutting device, showing the rim of the base, connection components, and slat elevation.

FIG. 5 is a perspective view of the collapsed material cutting device shown exploded for purposes of an exemplary illustration.

FIG. 6 is a flowchart illustrating the steps of a method for assembling and configuring the material cutting device.

### DETAILED DESCRIPTION

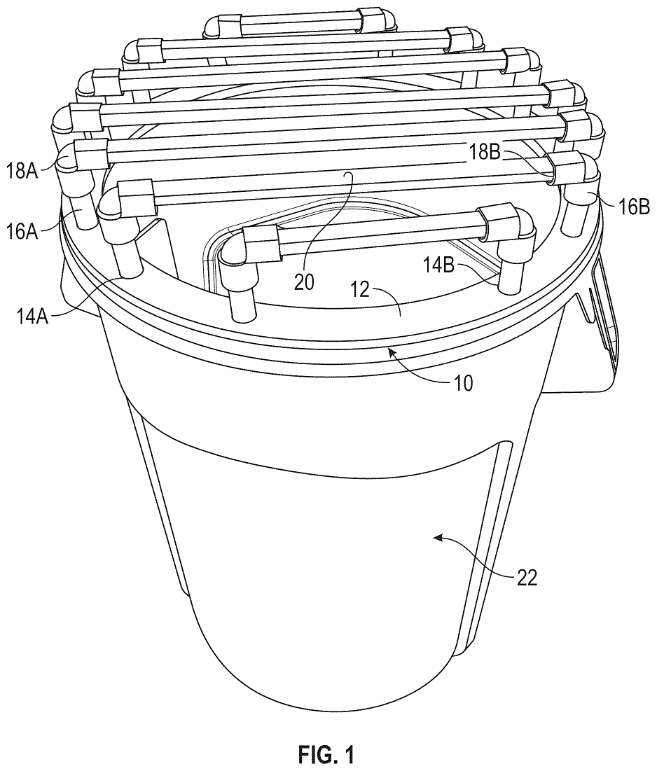

The present invention provides a modular and collapsible material support device 10 designed for versatility and ease of use. The device includes a base 12 with a plurality of slat mounting points 14A and 14B, which accommodate various components such as slat risers 16A and 16B, slat elbows 18A and 18B, and slats 20 of a multi-piece slat assembly or uni-slats (e.g., single piece slats resembling the shape and configuration of the multi-piece slat assembly). Base 12 is adaptable for use on multiple surfaces, including garbage containers 22, workbenches, trailers, or flat ground, as shown in FIG. 1.

Base 12 may include a rim 26 that allows secure mating with round, square, or rectangular containers. Additionally, base 12 may be configured with skid-resistant feet, adjustable leveling features, or other anti-skid enhancements to ensure stability on uneven or smooth surfaces. Protective surface enhancements, such as impact-resistant coatings or abrasion-resistant layers, may be applied to base 12 to guard against damage during various tasks.

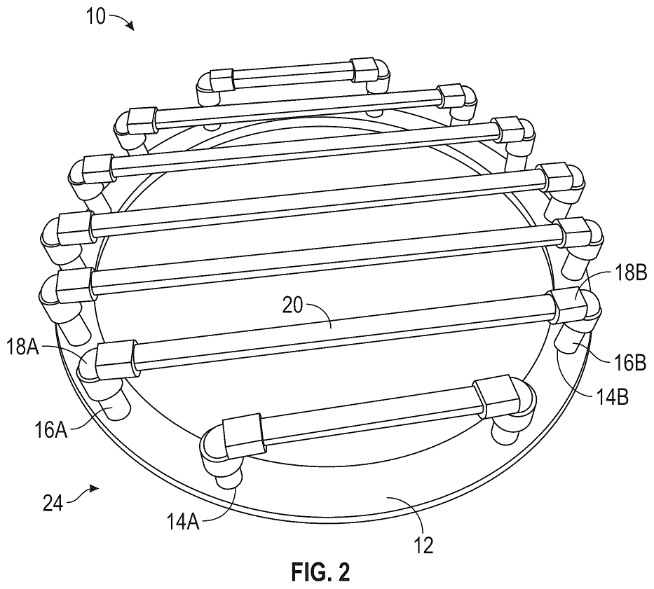

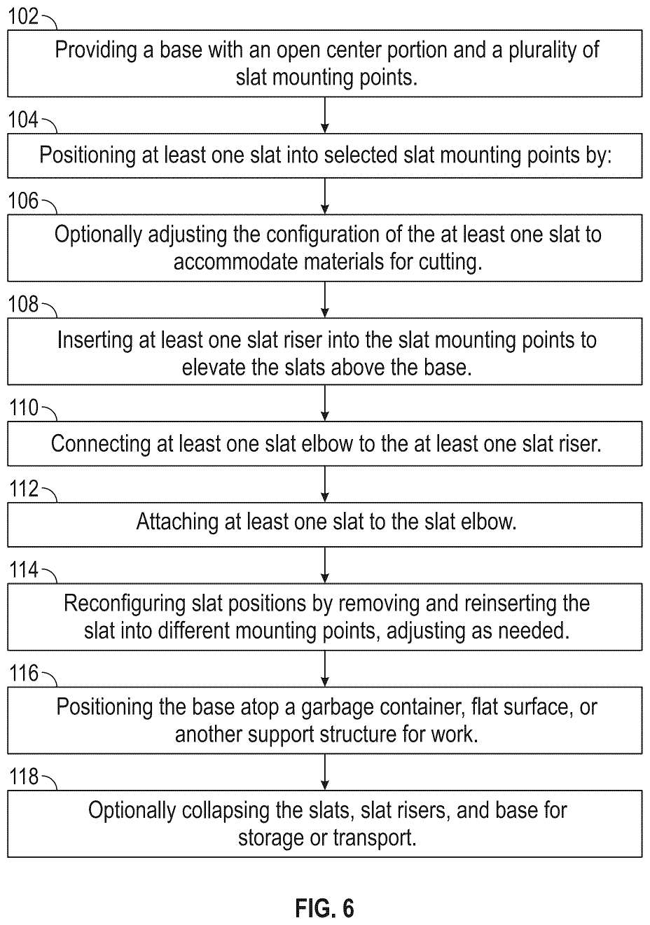

As illustrated in FIG. 2, slat mounting points 14A and 14B on base 12 enable flexible placement of slats 20. These points may be arranged equidistantly or in custom patterns to support a variety of configurations (Step 106). In Step 102 and Step 104 of FIG. 6, base 12 is provided, and slats 20 are positioned into selected slat mounting points 14A and 14 B.

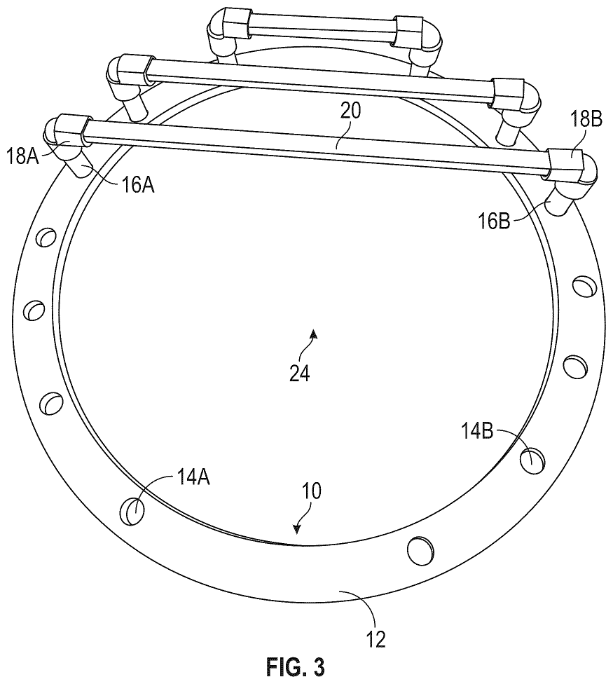

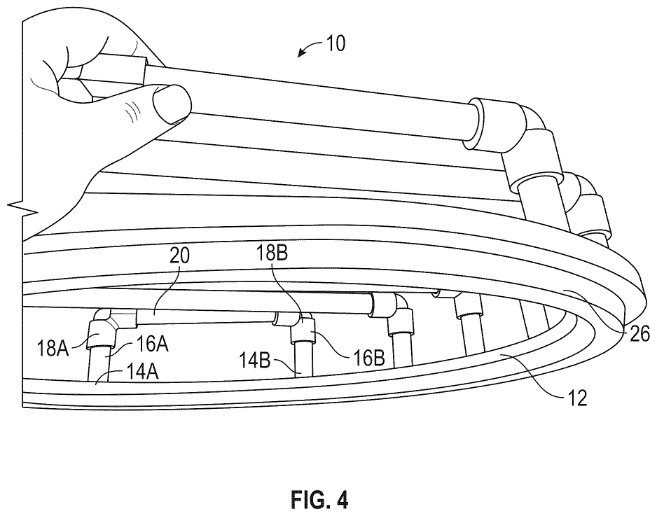

Slats 20 are elevated above base 12 using slat risers 16A and 16B and slat elbows 18A and 18B, as shown in Steps 108, Step 110 and FIG. 4. Slat risers 16A and 16B and slat elbows 18A and 18B allow for customization of slat height, spacing, and orientation, making the device adaptable for different materials and tasks. FIG. 3 depicts an assembled configuration, while Step 114 highlights the reconfigurable nature of slats 20. Users can remove slats 20 from one slat mounting point 14A and 14B and reposition them into another, adjusting for gaps, angles, or alignment as needed.

Slats 20 may be fabricated in various shapes and configurations, including round, square, or flat-surfaced designs. Non-round slats 20 with flat surfaces provide additional working area in contact with materials, while round slats 20 allow for minimal contact and easy movement of materials. Surface enhancements such as textured or rubberized coatings can add grip, while smooth surfaces enable materials to glide across slats 20 during use.

Connection points between slats 20, slat risers 16A and 16B, and slat elbows 18A and 18B are designed for versatility. Threaded connections provide rigid assemblies, while slip-fit and compression-fit connections enable quick assembly, disassembly, and reconfigurability. For multi-piece slats 20, such as slat assemblies that include one or more of slat risers 16A and 16B, slat elbows 18A and 18B, and slats 20, individual sections may be connected to form continuous slats 20, further enhancing adaptability.

FIG. 1 shows device 10 positioned on a garbage container 22, with the rim 26 providing secure alignment and fixation. Base 12 itself can be circular, rectangular, or other shapes, ensuring compatibility with different surfaces, such as square-mouthed type of garbage container 22 or flat workspaces.

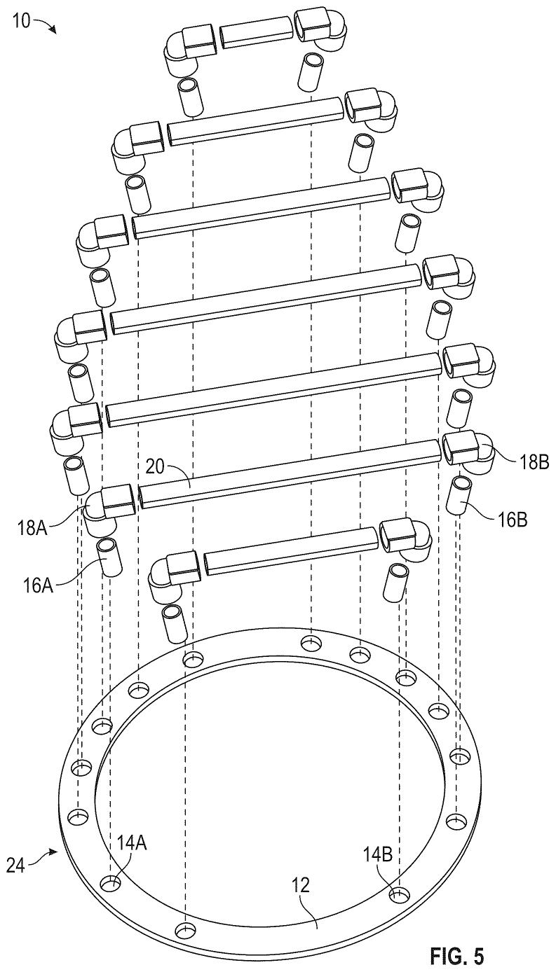

The assembly process, detailed in FIG. 6, begins with providing base 12 with slat mounting points 14A and 14B (Step 102) and positioning slats 20 into mounting points 14A and 14B (Step 104) with one or more of Steps 104-112. In at least one aspect, slat risers 16A and 16B are inserted into mounting points 14 to elevate the slats 20 (Step 108), and slat elbows 18A and 18B are connected to slat risers 16A and 16B (Step 110). Slats 20 are secured to slat elbows 18A and 18B (Step 112) and can be reconfigured as necessary (Step 114) in mounting points 14A and 14B. Device 10 can be placed on a chosen surface (Step 116) and collapsed as shown in FIG. 5 for storage or transport (Step 118).

By enabling slats 20, slat risers 16A and 16B, and slat elbows 18A and 18B to be configured and reconfigured, the invention supports a wide range of tasks. Its modular nature ensures adaptability, while its collapsible design shown in FIG. 5 promotes portability and easy storage.

The invention is not to be limited to the particular embodiments described herein. In particular, the invention contemplates numerous variations in a reconfigurable and collapsible material support device. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes or methods of the invention. It is understood that any other modifications, substitutions, and/or additions can be made, which are within the intended spirit and scope of the invention.

What is claimed is:

1. A material support device, comprising:
a base having an open center portion;
a plurality of slat mounting points disposed within the base; and
at least one slat removably connected to the plurality of slat mounting points;
wherein the at least one slat is supported at a distance above the base, and the base is configured to rest on various surfaces.

2. The device of claim 1, further comprising:
at least one slat riser removably inserted into the plurality of slat mounting points.

3. The device of claim 2, further comprising:
at least one slat elbow connected to the at least one slat riser, wherein the slat is connected to the at least one slat elbow.

4. The device of claim 1, wherein the slat positions are reconfigurable by selecting different slat mounting points on the base.

5. The device of claim 1, wherein the base includes a rim configured to mate with an opening of a garbage container.

6. The device of claim 1, wherein the at least one slat is elevated above the planar base when connected to the plurality of slat mounting points.

7. The device of claim 1, wherein the base is circular and planar.

8. A system for supporting materials for cutting, comprising:
a planar base with an open center portion and a rim for mating with container openings;
a plurality of slat mounting points disposed within the base; and
at least one slat removably connected to the plurality of slat mounting points;
wherein the system is reconfigurable to adjust the placement, orientation, and spacing of the at least one slat for supporting materials of varying sizes.

9. The system of claim 8, further comprising:
at least one slat riser removably inserted into the plurality of slat mounting points.

10. The system of claim 9, further comprising:
at least one slat elbow connected to the at least one slat riser, wherein the slat is connected to the at least one slat elbow.

11. The system of claim 8, wherein the slat positions are reconfigurable by removing and repositioning the at least one slat into different slat mounting points.

12. The system of claim 8, wherein the at least one slat is elevated above the planar base when connected to the plurality of slat mounting points.

13. The system of claim 8, wherein the rim of the base is shaped to fit a variety of container openings.

14. A method for assembling a material support device, the method comprising:
providing a base with an open center portion and a plurality of slat mounting points;
positioning at least one slat into selected ones of the plurality of slat mounting points; and
adjusting the configuration of the at least one slat to accommodate materials for cutting.

15. The method of claim 14, further comprising:
reconfiguring the positions of the slat by removing and inserting the slat into different ones of the plurality of slat mounting points.

16. The method of claim 14, further comprising:
inserting at least one slat riser into the plurality of slat mounting points.

17. The method of claim 16, further comprising:
connecting at least one slat elbow to the at least one slat riser, wherein the slat is removably connected to the at least one slat elbow.

18. The method of claim 14, further comprising:
positioning the base atop a garbage container for collecting debris during cutting.

19. The method of claim 14, wherein the at least one slat is elevated above the planar base when positioned in the plurality of slat mounting points.

20. The method of claim 14, further comprising:
collapsing the slats, slat risers, and base for storage or transport.
